(19) United States
(12) Patent Application Publication
(10) Pub. No.: US 2025/0187964 A1
(43) Pub. Date: Jun. 12, 2025

(54) ELECTRODE PROPULSION STRUCTURE WITH UNEQUAL PROPULSION AMOUNT BASED ON ELECTRODE EROSION RULE AND ELECTRODE PROPULSION METHOD

(71) Applicant: CAIHONG DISPLAY DEVICES CO., LTD., Xianyang (CN)

(72) Inventors: Chao YU, Xianyang (CN); Menglong WANG, Xianyang (CN); Longjiang ZHAO, Xianyang (CN); Yifan JIAO, Xianyang (CN)

(73) Assignee: CAIHONG DISPLAY DEVICES CO., LTD., Xianyang (CN)

(21) Appl. No.: 18/970,790

(22) Filed: Dec. 5, 2024

Related U.S. Application Data
(63) Continuation-in-part of application No. PCT/CN2024/092913, filed on May 13, 2024.

(30) Foreign Application Priority Data
Dec. 6, 2023 (CN) 202311668180.6

(51) Int. Cl. C03B 5/167; C03B 5/027; F27D 11/04; H05B 3/03

(52) U.S. Cl. CPC C03B 5/167; C03B 5/027; F27D 11/04; H05B 3/03

(57) ABSTRACT

An electrode propulsion structure with an unequal propulsion amount based on an electrode erosion rule and an electrode propulsion method are provided. The electrode propulsion structure comprises an electrode, a silver plate disposed within the electrode, and a plurality of propulsion modules disposed at a tail end of the electrode. The electrode includes a plurality of electrode blocks. At least one of the plurality of electrode blocks constitutes an electrode module. The silver plate includes a plurality of silver plate modules. At least one of a plurality of electrode modules is provided with a silver plate module and at least one of the plurality of propulsion modules corresponding to the at least one of plurality of propulsion modules.

### CROSS-REFERENCES TO RELATED APPLICATIONS

This application is a Continuation-In-Part of International Patent Application No. PCT/CN2024/092913, filed on May 13, 2024, which claims priority to Chinese Patent Application No. 202311668180.6, filed on Dec. 6, 2023, the entire contents of each of which are incorporated herein by reference.

### TECHNICAL FIELD

The present disclosure relates to the technical field of substrate glass manufacturing, and in particular to an electrode propulsion structure with an unequal propulsion amount based on an electrode erosion rule and an electrode propulsion method.

### BACKGROUND

The kiln is a crucial component in the production process of substrate glass. The pattern of electrode erosion varies across different regions of the same electrode due to the existence and distribution of flow fields within the kiln. For instance, the upper portion of the electrode experiences minimal erosion, whereas the lower portion shows significant erosion. Similarly, the middle section has slight erosion, while the sides are subject to considerable erosion.

The existing electrode propulsion system uses a uniform propulsion approach, meaning the propulsion amount of each electrode block of the electrode is the same. This results in narrower spacing between electrode blocks that experience less consumption within each pair of electrodes. Due to the reduced spacing and the low resistivity of the glass melt, the electric current concentrates on these electrode blocks, causing uneven current distribution across the electrodes and the glass melt, which ultimately leads to uneven melting of the glass. Furthermore, using uniform propulsion increases the depth at which less consumed electrode blocks are inserted into the glass, thereby accelerating consumption and reducing the overall service life of the electrodes. Additionally, this uniform propulsion amount disrupts the alignment between the electrodes and a wall of the kiln, further exacerbating the erosion of wall bricks near the electrodes.

To address the technical challenges of uneven current distribution in electrodes and liquid glass, high electrode block consumption, and the rapid erosion of wall bricks near electrodes under the current uniform propulsion method, there is an urgent need for a new electrode propulsion approach. This new method should maintain the contact surface between the electrodes and the liquid glass as a consistent plane, ensuring uniform current distribution and even melting of the liquid glass within the kiln. It should also optimize the utilization of each electrode block, thereby extending the overall service life of the electrodes.

To address the shortcomings of the prior art, the present disclosure aims to introduce an electrode propulsion structure with an unequal propulsion amount based on electrode erosion patterns, along with a corresponding propulsion method. This innovation seeks to resolve the issues inherent in the existing uniform propulsion approach, such as uneven current distribution in electrodes and the liquid glass, excessive consumption of electrode blocks, and accelerated erosion of wall bricks near the electrodes.

### SUMMARY

One or more embodiments of the present disclosure provide an electrode propulsion structure with an unequal propulsion amount based on an electrode erosion rule. The electrode propulsion structure may comprise an electrode, a silver plate disposed within the electrode, and a plurality of propulsion modules disposed at a tail end of the electrode. The electrode may include a plurality of electrode blocks. At least one of the plurality of electrode blocks may constitute an electrode module. The silver plate may include a plurality of silver plate modules. At least one of a plurality of electrode modules may be provided with a silver plate module and at least one of the plurality of propulsion modules corresponding to the at least one of plurality of propulsion modules.

One or more embodiments of the present disclosure further provide an electrode propulsion method. The electrode propulsion method may comprise establishing an erosion amount calculation model for at least one of a plurality of electrode blocks at multiple temperatures based on an erosion rule of an electrode after a kiln is disassembled and an erosion rule analysis of the electrode simulated by a kiln flow field; determining a total erosion amount of the plurality of electrode blocks in operation based on the erosion amount calculation model; grouping electrode blocks with a same or similar erosion amount to constitute an electrode module based on the total erosion amount of the plurality of electrode blocks; designing a plurality of silver plate modules and a plurality of propulsion modules corresponding to a plurality of electrode modules according to the plurality of electrode modules; optimizing a length of each of the plurality of electrode blocks based on the total erosion amount of the plurality of electrode blocks; determining a daily consumption of the plurality of electrode blocks based on a service life of the kiln and the total erosion amount of the plurality of electrode blocks; correcting the daily consumption of the plurality of electrode blocks based on the erosion rule analysis of the electrode simulated by the kiln flow field; determining an electrode consumption of the plurality of electrode modules during an electrode propulsion cycle based on the electrode propulsion cycle; and propelling the electrode with unequal propulsion amounts by the plurality of propulsion modules based on the electrode consumption of the plurality of electrode modules during the electrode propulsion cycle.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, where:

FIG. 1 is a front view illustrating an electrode propulsion structure with an unequal propulsion amount based on an electrode erosion rule according to some embodiments of the present disclosure;

FIG. 2 is a side view illustrating an electrode propulsion structure with an unequal propulsion amount based on an electrode erosion rule according to some embodiments of the present disclosure;

FIG. 3 is a longitudinal cross-sectional view illustrating an electrode propulsion structure with an unequal propulsion amount based on an electrode erosion rule according to some embodiments of the present disclosure;

FIG. 4 is a schematic structural diagram illustrating an electrode block according to some embodiments of the present disclosure;

FIG. 5 is a schematic structural diagram illustrating a propulsion module according to some embodiments of the present disclosure;

FIG. 6 is a flowchart illustrating an exemplary propulsion method of an electrode propulsion structure with an unequal propulsion amount based on an electrode erosion rule according to some embodiments of the present disclosure;

FIG. 7 is a schematic diagram illustrating an exemplary process of determining an electrode propulsion cycle according to some embodiments of the present disclosure; and

FIG. 8 is a schematic diagram illustrating an exemplary process of determining a propulsion amount according to some embodiments of the present disclosure.

### REFERENCE SIGNS

1—electrode; 1-1—electrode block; 1-2—electrode module; 1-11—step groove; 2—silver plate; 2-1—silver plate block; 2-2—silver plate module; 3—electric flange; 4—propulsion module; 4-1—electrode module top plate; 4-2—top screw; 4-3—propulsion support.

### DETAILED DESCRIPTION

The present disclosure will be further described in detail below with reference to specific drawings and embodiments, which are intended to explain the present disclosure rather than limit the present disclosure.

In order to enable those skilled in the art to better understand the solution of the present disclosure, the technical solution in the embodiments of the present disclosure will be clearly and completely described below with reference to the drawings in the embodiments of the present disclosure. Obviously, the described embodiments are only part of the embodiments of the present disclosure, not all of the embodiments. All other embodiments obtained by those having ordinary skills in the art based on the embodiments of the present disclosure without creative work should fall within the scope of protection of the present disclosure.

It should be noted that the terms “first,” “second”, etc., in the specification and claims of the present disclosure and the above drawings are used to distinguish similar objects, and are not necessarily used to describe a specific order or sequence. It should be understood that the data used in this way can be interchanged where appropriate, so that the embodiments of the present disclosure described herein can be implemented in an order other than those illustrated or described herein. In addition, the terms “including,” and “having” and any variations thereof are intended to cover non-exclusive inclusions, for example, a process, method, system, product or device that includes a series of steps or units is not necessarily limited to those steps or units that are clearly listed, but may include other steps or units that are not clearly listed or inherent to the process, method, product, or device.

Flowcharts are used in the present disclosure to illustrate the operations performed by a system according to embodiments of the present disclosure. It should be appreciated that the preceding or following operations are not necessarily performed in an exact sequence. Instead, steps can be processed in reverse order or simultaneously. Also, it is possible to add other operations to these processes or to remove a step or steps from these processes.

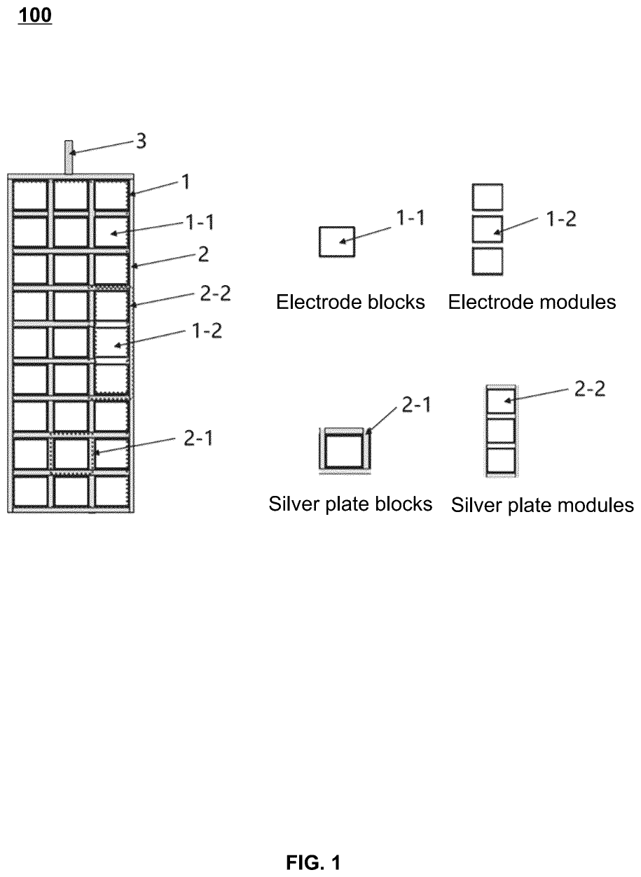

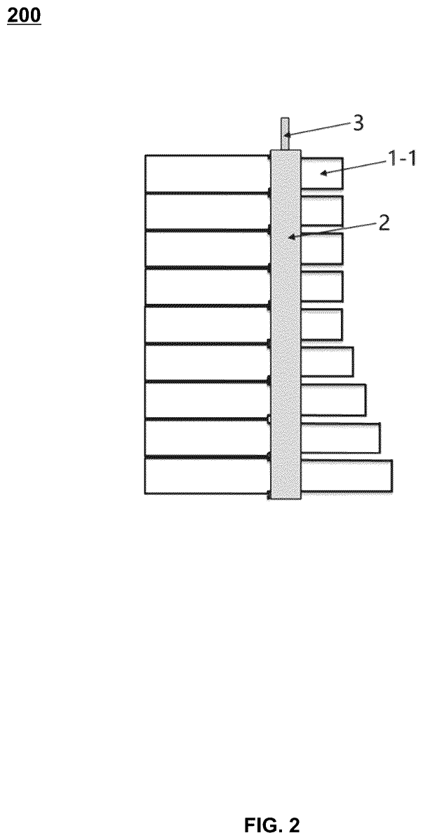

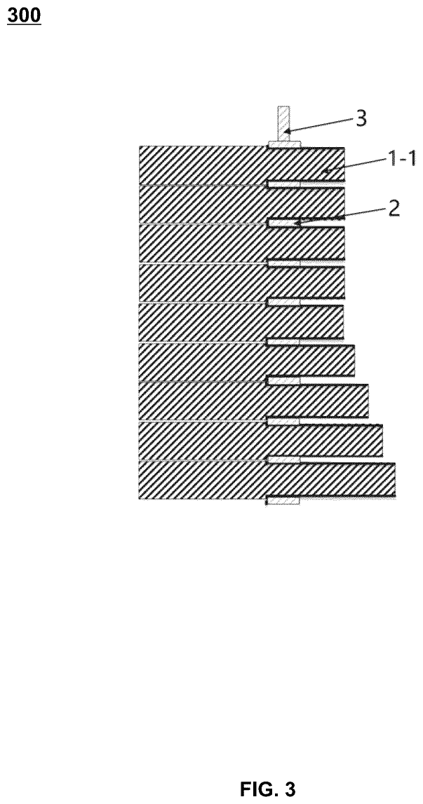

FIG. 1 is a front view illustrating an electrode propulsion structure with an unequal propulsion amount based on an electrode erosion rule according to some embodiments of the present disclosure. FIG. 2 is a side view illustrating an electrode propulsion structure with an unequal propulsion amount based on an electrode erosion rule according to some embodiments of the present disclosure. FIG. 3 is a longitudinal cross-sectional view illustrating an electrode propulsion structure with an unequal propulsion amount based on an electrode erosion rule according to some embodiments of the present disclosure.

The embodiments of the present disclosure provide an electrode propulsion structure with an unequal propulsion amount based on an electrode erosion rule. The electrode propulsion structure may include an electrode 1, a silver plate 2 disposed within the electrode 1, and a plurality of propulsion modules 4 disposed at a tail end of the electrode 1. More descriptions regarding the plurality of propulsion modules 4 may be found in FIG. 5 and related descriptions thereof.

The electrode 1 refers to a component for current conduction. In a manufacturing process of a substrate glass, the electrode 1 is used for heating or participating in a chemical reaction, and is one of the important components in glass melting and processing. A material of the electrode 1 may include platinum, tungsten, etc. The electrode 1 in this embodiment may be used in a kiln to melt a glass raw material with resistance heat generated by a current passing through the electrode 1, thereby ensuring a homogenization of glass composition and reducing impurities. The electrode 1 in this embodiment may be further configured to accurately control a temperature generated by the electrode 1 by adjusting the current, thereby providing corresponding thermal management at different production stages and improving the quality of the substrate glass.

In this embodiment, cooling air may be provided near the electrode 1 to dissipate heat on a surface of the electrode 1 and vicinity thereof. For example, the cooling air provided near the electrode 1 may be provided by an air source. The air source may include a fan, a blower, a nozzle, an air duct network, etc. The electrode 1 and components around are exposed to a high temperature for a long time, which may cause deformation or oxidization of the electrode 1. The cooling air provides a direct and effective cooling mode for maintaining a normal operation temperature of the electrode 1.

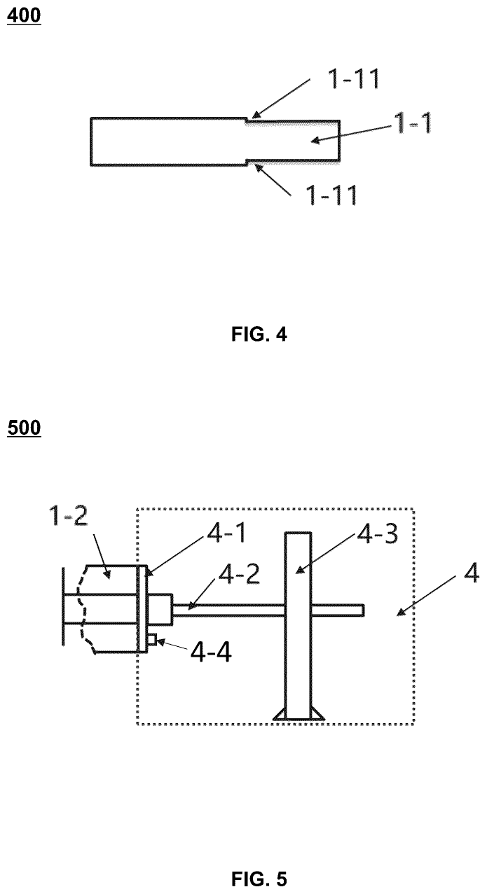

FIG. 4 is a schematic structural diagram illustrating an electrode block according to some embodiments of the present disclosure.

In this embodiment, the electrode 1 may include a plurality of electrode blocks 1-1. At least one of the plurality of electrode blocks 1-1 may be a cuboid electrode block. Step grooves 1-11 may be disposed at a periphery of the cuboid electrode block.

In this embodiment, the plurality of electrode blocks 1-1 may be configured to evenly distribute heat in a glass material to prevent local overheating or avoid uneven heating, thereby improving the quality of the substrate glass. For example, the plurality of electrode blocks 1-1 may accurately control a temperature of the substrate glass by adjusting a current to achieve good temperature control and process adjustment, thereby meeting the process requirements of different production stages.

In this embodiment, a depth of each of the step grooves 1-11 of the electrode block 1-1 may be determined through a current density, an electrode material, and temperature control.

In this embodiment, at least one of the plurality of electrode blocks 1-1 may constitute an electrode module 1-2. For example, a single electrode block 1-1 may be used as an electrode module 1-2 alone. As another example, a plurality of electrode blocks 1-1 may be combined to constitute an electrode module 1-2.

In this embodiment, the electrode 1 may include a plurality of electrode modules 1-2, and each of the plurality of electrode modules 1-2 may consist of a single electrode block 1-1. In this embodiment, the electrode 1 may include a plurality of electrode modules 1-2, and each of the plurality of electrode modules 1-2 may consist of more than one electrode block 1-1. In this embodiment, the electrode 1 may include a plurality of electrode modules 1-2. In the plurality of electrode modules 1-2, a count of electrode modules 1-2 consisting of a single electrode block 1-1 needs to satisfy a preset condition, or a count of electrode modules 1-2 consisting of more than one electrode block 1-1 needs to satisfy a preset condition. The preset condition may include that a percentage of the count of the electrode modules 1-2 consisting of more than one electrode block 1-1 to a total count of the electrode modules 1-2 may be greater than or equal to a preset percentage threshold. For example, the percentage of the count of the electrode modules 1-2 consisting of more than one electrode block 1-1 to a total count of the electrode modules 1-2 may be greater than or equal to 50%.

In this embodiment, an erosion amount of at least one electrode block 1-1 constituting the electrode module 1-2 may be the same or similar. The erosion amount of the electrode block 1-1 refers to a degree that the electrode block 1-1 is corroded or worn. For example, some compositions in the glass may cause the electrode material to dissolve or form corrosion products. As another example, an electrochemical reaction (e.g., an electrode oxidation or reduction reaction) causes the electrode material to gradually erode. By effectively managing the erosion amount of the electrode block 1-1, the service life of the electrode 1 may be extended, the production efficiency may be improved, and the high-quality output of the product may be ensured.

In the embodiments of the present disclosure, the electrode module 2-2 consists of a single electrode block 1-1 or consists of more than one electrode block 1-1, which may achieve the effect of propulsion of adjacent electrode blocks 1-1 with the same or similar erosion amount together, thereby improving the propulsion efficiency.

The silver plate 2 refers to a silver coating or a silver plated layer embedded in the electrode 1. The silver plate 2 may be configured to resist the influence of corrosion, oxidation, etc., on the electrode 1 to increase the durability of the electrode 1. In this embodiment, the silver plate 2 may be configured to be embedded in the step grooves 1-11 of two electrode blocks 1-1, and the silver plate 2 may be connected in series. The series connection of the silver plate 2 may be achieved by an electrical series connection. For example, a silver circuit is created by an etching process, and the series connection of the silver circuit is achieved by a printing technique, thereby achieving the series connection of the silver plate 2. In this embodiment, the series connection of the silver plate 2 refers to a series connection between a plurality of silver plate blocks constituting the silver plate 2. More descriptions regarding the plurality of silver plate blocks and the series connection between the plurality of silver plate blocks may be found in the present disclosure blow, which are not repeated here.

In this embodiment, an electric flange 3 may be disposed on a top of the silver plate 2. The silver plate 2 may be further configured to uniformly transmit electricity in the electric flange 3 to each electrode module 1-2, thereby ensuring the uniformity of current distribution in the electrode 1. The electric flange 3 refers to a flange component for electrical connection. The flange component is configured for conductive contact and mechanical connection between devices or components. The electric flange 3 combines the mechanical connection function and the conductive function of the flange, and is configured in occasions of current transmission, grounding, or electrical isolation.

In the embodiments of present disclosure, the electric flange 3 is disposed at the top of the silver plate 2, and the silver plate 2 uniformly conducts the electricity in the electric flange 3 to each electrode module 1-2, thereby ensuring the uniformity of current distribution in the electrode 1. Meanwhile, cooling air may be provided near the electrode 1. The cooling air enables good heat dissipation on a surface of the electrode 1 and the vicinity thereof.

In this embodiment, the silver plate 2 may include a plurality of silver plate blocks 2-1. The plurality of silver plate blocks 2-1 may be configured to constitute a plurality of silver plate modules 2-2.

In this embodiment, at least one of the plurality of silver plate blocks 2-1 may be embedded in the step grooves 1-11 of the adjacent electrode blocks 1-1. The plurality of silver plate blocks 2-1 may be connected in series. The plurality of silver plate blocks 2-1 may be connected in series through a conductive path. For example, the plurality of silver plate blocks 2-1 may be connected in series through a plurality of silver circuits. As another example, the plurality of silver plate blocks 2-1 may be connected in series through a conductive adhesive. As another example, the plurality of silver plate blocks 2-1 may be connected in series by bridging a plurality of conductive paths through silver paste.

In the embodiments of the present disclosure, at least one of the plurality of electrode blocks 1-1 may be the cuboid electrode block. The step grooves 1-11 may be disposed at the periphery of the cuboid electrode block. At least one of the plurality of silver plate blocks 2-1 may be embedded in the step grooves 1-11 of the adjacent electrode blocks 1-1. All the silver plate blocks 2-1 may be connected in series, so as to ensure that a front end of the electrode 1 fits each other.

In this embodiment, a width of each of the plurality of silver plate blocks 2-1 may be less than the depth of each of the step grooves 1-11.

In the embodiments of the present disclosure, the width of each of the plurality of silver plate blocks 2-1 may be less than the depth of each of the step grooves 1-11, such that a contact area between the cooling air and the electrode 1 is increased, which facilitates the heat dissipation of the electrode 1.

In this embodiment, the silver plate 2 may include a plurality of silver plate modules 2-2. The plurality of silver plate module 2-2 may be designed according to the plurality of electrode modules 1-2. For example, when a single electrode block 1-1 is used as the electrode module 1-2, a silver plate module 2-2 of the plurality of silver plate modules 2-2 may consist of a single silver plate block 2-1. When a plurality of electrode blocks 1-1 are combined to constitute the electrode module 1-2, a silver plate module 2-2 of the plurality of silver plate modules 2-2 may consist of a combination of more than one silver plate block 2-1.

In the embodiments of the present disclosure, the plurality of silver plate modules 2-2 may be designed according to the plurality of electrode modules 1-2. When a single electrode block 1-1 is used as the electrode module 1-2, a silver plate module 2-2 of the plurality of silver plate modules 2-2 may consist of a single silver plate block 2-1. When a plurality of electrode blocks 1-1 are combined to constitute the electrode module 1-2, a silver plate module 2-2 of the plurality of silver plate modules 2-2 may consist of a combination of more than one silver plate block 2-1, thereby ensuring the uniform current distribution of the electrode 1. Meanwhile, the plurality of silver plate modules 2-2 may be designed according to the plurality of electrode blocks 1-1, such that a mutual independence between the plurality of electrode modules 1-2 is ensured, unequal propulsion amounts of the plurality of electrode modules 1-2 are achieved, thereby ensuring that the contact surface between the electrode 1 and the liquid glass is a plane, and achieving the uniform current distribution of the electrode 1 and the liquid glass.

In this embodiment, no silver plate block 2-1 is disposed in a middle region of the silver plate module 2-2 that is consisted of more than one silver plate block 2-1.

FIG. 5 is a schematic structural diagram illustrating a propulsion module according to some embodiments of the present disclosure.

The plurality of propulsion modules 4 are configured for controlling and positioning the plurality of electrode blocks 1-1 of the electrode 1. In this embodiment, the plurality of propulsion modules 4 may be configured to adjust propulsion amounts of the plurality of electrode blocks 1-1 to adjust the distribution and conduction of the current, thereby improving the efficiency and quality of glass melting or molding. For example, the plurality of propulsion modules 4 may be configured to adjust a depth of the plurality of electrode blocks 1-1 inserted into the glass to adjust the current distribution of the electrode 1 and the liquid glass.

In this embodiment, the plurality of propulsion modules 4 may be further configured to provide support for the electrode 1, such that the electrode 1 remains stable in a high temperature and corrosive environment, thereby extending the service life of the electrode 1, and reducing current interruption or instability caused by mechanical displacement.

In this embodiment, the plurality of propulsion modules 4 may be provided with a sensor and a control system for real-time monitoring of the state and performance of the electrode 1, thereby simplifying the maintenance process of the electrode 1 and improving the production efficiency.

In this embodiment, each of the plurality of propulsion modules 4 may include an electrode module top plate 4-1, a top screw 4-2, and a propulsion support 4-3. One end of the top screw 4-2 may be fixed on the electrode module top plate 4-1, and the other end of the top screw 4-2 may be connected with the propulsion support 4-3.

In this embodiment, the electrode module top plate 4-1 may be designed according to each of the plurality of electrode modules 1-2 and used in conjunction with each of the plurality of electrode modules 1-2. The plurality of propulsion modules 4 may include a plurality of electrode module top plates 4-1 which are independent of each other. Each of the plurality of electrode module top plates 4-1 may be disposed at a tail end of the corresponding electrode module 1-2. One end of the top screw 4-2 may press against each of the plurality of electrode module top plates 4-1 and may be insulated from each other, and the other end of the top screw 4-2 may be connected with the propulsion support 4-3. The propulsion support 4-3 may be fixed on the ground.

In the embodiments of the present disclosure, a pressure sensor 4-4 may be disposed on each of the plurality of electrode module top plates 4-1. The pressure sensor 4-4 may be configured to obtain pressure data when the plurality of electrode modules 1-2 are propelled through the plurality of electrode module top plates 4-1. The plurality of electrode modules 1-2 may be propelled during a melting process or a non-melting process.

In the embodiments of the present disclosure, the pressure data obtained by the pressure sensor 4-4 may be configured to determine an erosion condition of a front end of each electrode block 1-1 that constitutes the electrode module 1-2, so as to determine an erosion amount or an propulsion amount of the electrode module 1-2 or the electrode block 1-1 of the electrode module 1-2. For example, the pressure sensor may obtain the pressure data when the electrode module 4-41-2 or the electrode block 1-1 of the electrode module 1-2 is propelled during the melting process.

In the embodiments of the present disclosure, by providing the pressure sensor 4-4 on the electrode module top plate 4-1, the pressure data of the electrode module 1-2 corresponding to the electrode module top plate 4-1 can be obtained in real time, such that the erosion condition of the front end of the electrode block 1-1 constituting the electrode module 1-2 can be obtained and determined in real time, and the erosion amount or the propulsion amount of the electrode module 1-2 or the electrode block 1-1 of the electrode module 1-2 can be determined accurately.

In the embodiments of the present disclosure, each of the plurality of propulsion modules 4 may include the electrode module top plate 4-1, the top screw 4-2, and the propulsion support 4-3 which are disposed at a tail end of each of the plurality of electrode modules 1-2 in sequence. One end of the top screw 4-2 may be fixed on the electrode module top plate 4-1 and insulated from each other, and the other end of the top screw 4-3 may be connected with the propulsion support 4-3. The propulsion support 4-3 may be fixed on the ground to ensure that each of the plurality of electrode modules 1-2 can be smoothly propelled.

In the embodiments of the present disclosure, the electrode module top plate 4-1 is used in conjunction with each of the plurality of electrode modules 1-2, and the plurality of propulsion modules 4 include the plurality of electrode module top plates 4-1 which are independent of each other, such that the plurality of electrode modules 1-2 do not interfere with each other during the propulsion process with unequal propulsion amounts.

The embodiments of the present disclosure provide an electrode propulsion structure with an unequal propulsion amount based on an electrode erosion rule. The electrode propulsion structure may comprise the electrode 1, the silver plate 2 disposed within the electrode, and the plurality of propulsion modules 4 disposed at a tail end of the electrode 1 for propelling the electrode 1. The electrode 1 may include the plurality of electrode blocks 1-1. Electrode blocks 1-1 with a same or similar erosion amount may be grouped to constitute an electrode module 1-2. Different electrode modules 1-2 may be provided with corresponding silver plate modules 2-2 and corresponding propulsion modules 4. Different electrode modules 1-2 may correspond to different total propulsion amounts, which can realize unequal propulsion amounts of the plurality of electrode blocks 1-1 in the electrode 1, effectively ensure that the contact surface between the electrode 1 and the liquid glass is always a plane and flush with a wall, and realize uniform current distribution of the electrode 1 and the liquid glass, thereby realizing uniform melting of the liquid glass in the kiln while improving efficient utilization of each electrode block 1-1, and extending the service life of the electrode 1.

### Example 1

The embodiments of the present disclosure provide an electrode propulsion structure with an unequal propulsion amount based on an electrode erosion rule. The electrode propulsion structure comprises an electrode 1, a silver plate 2 disposed within the electrode 1, and a plurality of propulsion modules 4 disposed at a tail end of the electrode 1. The electrode 1 includes a plurality of electrode blocks 1-1. Electrode blocks 1-1 with a same or similar erosion amount are grouped to constitute an electrode module 1-2. Different electrode modules 1-2 are provided with corresponding silver plate modules 2-2 and corresponding propulsion modules 4.

### Example 2

The embodiments of the present disclosure provide an electrode propulsion structure with an unequal propulsion amount based on an electrode erosion rule. The electrode propulsion structure comprises an electrode 1, a silver plate 2 disposed within the electrode 1, and a plurality of propulsion modules 4 disposed at a tail end of the electrode 1. The electrode 1 includes a plurality of electrode blocks 1-1. Electrode blocks 1-1 with a same or similar erosion amount are grouped to constitute an electrode module 1-2. Different electrode modules 1-2 are provided with corresponding silver plate modules 2-2 and corresponding propulsion modules 4. The electrode module 1-2 consists of a single electrode block 1-1, and the silver plate module 2-2 is designed according to the electrode module 1-2. The silver plate module 2-2 consists of a single silver plate block 2-1. The electrode block 1-1 is a cuboid electrode block, and step grooves 1-11 are disposed at a periphery of the cuboid electrode block. The silver plate block 2-1 is embedded in the step grooves 1-11 of adjacent electrode blocks 1-1. All the silver plates 2-1 are connected in series. Each of the plurality of propulsion modules 4 includes an electrode module top plate 4-1, a top screw 4-2, and a propulsion support 4-3 which are disposed at the tail end of each of the plurality of electrode modules 1-2 in sequence. One end of the top screw 4-2 is fixed on the electrode module top plate 4-1 and insulated from each other, and the other end of the top screw 4-2 is connected with the propulsion support 4-3. The propulsion support 4-3 is fixed on the ground. Cooling air is provided near the electrode 1. The cooling air enables good heat dissipation on a surface of the electrode 1 and the vicinity thereof. An electric flange 3 is disposed at a top end of the silver plate 2. The silver plate 2 uniformly transmits electricity in the electric flange 3 to each electrode module 1-2 to ensure the uniformity of the current distribution in the electrode 1.

### Example 3

The embodiments of the present disclosure provide an electrode propulsion structure with an unequal propulsion amount based on an electrode erosion rule. The electrode propulsion structure comprises an electrode 1, a silver plate 2 disposed within the electrode 1, and a plurality of propulsion modules 4 disposed at a tail end of the electrode 1. The electrode 1 includes a plurality of electrode blocks 1-1. Electrode blocks 1-1 with a same or similar erosion amount are grouped to constitute an electrode module 1-2. Different electrode modules 1-2 are provided with corresponding silver plate modules 2-2 and corresponding propulsion modules 4. The electrode module 1-2 consists of more than one electrode block 1-1, and the silver plate module 2-2 is designed according to the electrode module 1-2. The silver plate module 2-2 consists of more than one silver plate block 2-1. No silver plate block 2-1 is disposed in a middle region of the silver plate module 2-2 consisting of more than one silver plate block 2-1. At least one of the more than one electrode block 1-1 is a cuboid electrode block, and step grooves 1-11 are disposed at a periphery of the cuboid electrode block. At least one of the more than one silver plate block 2-1 is embedded in step grooves 1-11 of adjacent electrode blocks 1-1. All the silver plates 2-1 are connected in series. A width of each of the more than one silver plate block 2-1 is less than a depth of each of the step grooves 1-11. Each of the plurality of propulsion modules 4 includes an electrode module top plate 4-1, a top screw 4-2, and a propulsion support 4-3 which are disposed at the tail end of each of the plurality of electrode modules 1-2 in sequence. One end of the top screw 4-2 is fixed on the electrode module top plate 4-1 and insulated from each other, and the other end of the top screw 4-2 is connected with the propulsion support 4-3. The propulsion support 4-3 is fixed on the ground. The electrode module top plate 4-1 is used in conjunction with each of the plurality of electrode modules 1-2, and the plurality of propulsion modules 4 include a plurality of electrode module top plates 4-1 which are independent of each other. An electric flange 3 is disposed at a top end of the silver plate 2. Cooling air is provided near the electrode 1. The cooling air enables good heat dissipation on a surface of the electrode 1 and the vicinity thereof.

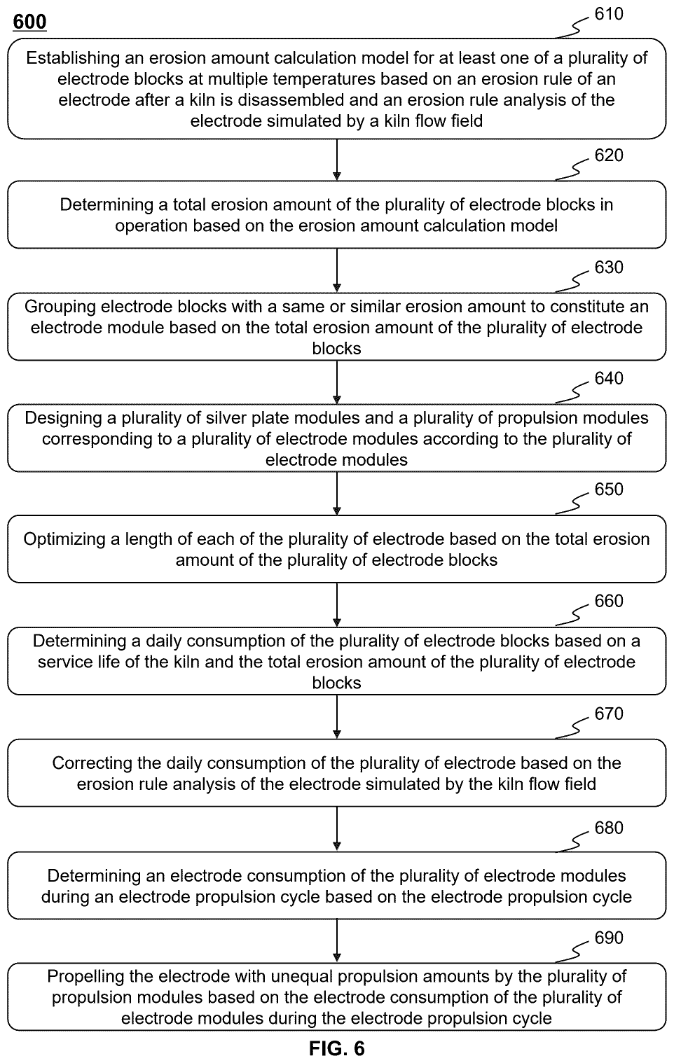

FIG. 6 is a flowchart illustrating an exemplary propulsion method of an electrode propulsion structure with an unequal propulsion amount based on an electrode erosion rule according to some embodiments of the present disclosure. As shown in FIG. 6, a process 600 may include the following operations. In some embodiments, the process 600 may be performed by a processor.

In the embodiments of the present disclosure, the electrode propulsion structure with the unequal propulsion amount based on the electrode erosion rule may include the processor (not shown in the figure). For example, the processor may be located at a bottom of the propulsion support 4-3. In the embodiments of the present disclosure, the electrode propulsion structure with the unequal propulsion amount based on the electrode erosion rule may be electrically connected with and communicate with an external processor. In the embodiments of the present disclosure, the processor may be configured to convert, through signal processing, a signal into a control and adjustment instruction that can be transmitted through the electrode 1, so as to control and manage the plurality of electrode blocks 1-1 of the electrode 1 through the plurality of propulsion modules 4, and acquire, store, and transmit information related to the plurality of electrode blocks 1-1 (e.g., a total erosion amount of the plurality of electrode blocks 1-1, etc.), etc.

In 610, an erosion amount calculation model for at least one of a plurality of electrode blocks at multiple temperatures may be established based on an erosion rule of an electrode after a kiln is disassembled and an erosion rule analysis of the electrode simulated by a kiln flow field.

The kiln is one the critical devices in the production process of a substrate glass. The kiln is configured to melt raw materials and form the substrate glass under a specific condition. With the passage of time and the accumulation of use, components (e.g., an electrode, a refractory material, etc.) inside the kiln are worn or corroded, so the kiln needs to be disassembled and maintained regularly.

The electrode erosion rule refers to a rule of material degradation of the electrode caused by environmental, chemical, and physical factors during use of the electrode. The electrode erosion rule varies depending on a material, an application environment, and a process parameter. In the embodiments of the present disclosure, the factors affecting the electrode erosion rule of the electrode 1 may include a thermal stress, a chemical corrosion, an electrochemical reaction, a mechanical wear, an oxidation, a material selection, and a coating, etc. For example, a glass melt in the kiln contains various chemical compositions (e.g., an alkali metal oxide, borosilicate, etc.), which may react chemically with a material (e.g., a precious metal, an alloy, etc.) of the electrode 1, resulting in corrosion and dissolution of the material of the electrode 1.

Simulation of the kiln flow field is used to analyze and predict physical and chemical processes inside the kiln, so as to provide a quantitative analysis basis for the analysis of the electrode erosion rule. The erosion rule analysis of the electrode simulated by the kiln flow field may include a temperature distribution, fluid dynamics, a chemical concentration field, a current density distribution, a pressure field, a multiphase flow effect, etc. For example, a region of concentrated thermal stress is identified by simulating the temperature distribution inside the kiln. Uneven temperature causes the thermal stress and metal fatigue, accelerating the physical degradation of the electrode. As another example, a potential high current density region where electrochemical erosion may occur is identified by simulating a current distribution on the surface of the electrode 1.

The erosion amount calculation model refers to a model for calculating an erosion amount of each of a plurality of electrode blocks. In the embodiments of the present disclosure, the erosion amount calculation model is a mathematical model that is constructed based on historical data that affects electrode erosion and characterizes the correlation between the erosion rule of the electrode 1 and a total erosion amount of the plurality of electrode blocks 1-1. The erosion amount calculation model may be configured to determine the total erosion amount of the plurality of electrode blocks 1-1 based on a chemical composition of a liquid glass, an operation temperature, a pressure field, a current density distribution, an operation time, and a device parameter (e.g., a flow speed, a stirring rate, etc.). More descriptions regarding the total erosion amount of the plurality of electrode blocks 1-1 may be found in operation 620 and related instructions thereof.

The processor may establish the erosion amount calculation model in various ways. In the embodiments of the present disclosure, the processor may obtain an actual erosion amount, a temperature condition, an exposure time, a loss morphology, and other electrode block features of a disassembled electrode block 1-1. The processor may obtain a fluid dynamic feature, a current distribution, a thermal distribution, and other influence factors at different temperatures through simulation of the kiln flow field. The processor may establish the erosion amount calculation model for each of the plurality of electrode blocks 1-1 at multiple temperatures based on features of the disassembled electrode block and the influence factors.

In 620, a total erosion amount of the plurality of electrode blocks 1-1 in operation may be determined based on the erosion amount calculation model.

The total erosion amount of the plurality of electrode blocks refers to a total amount of material consumed by the plurality of electrode blocks due to chemical, physical and electrochemical effects at a certain temperature within a certain period of time. In the embodiments of the present disclosure, the total erosion amount may include at least an electrochemical corrosion loss, a physical wear loss, and a chemical corrosion loss. The total erosion amount may be expressed by a volume loss (cm³), a mass loss (g/kg), a length loss (mm/cm), etc. For example, the total erosion amount of the plurality of electrode blocks 1-1 at 1500° C. within 1 h is 54.50 g. As another example, the total erosion amount of the plurality of electrode blocks 1-1 at 1500° C. within 1 h is 100 mm.

In the embodiments of the present disclosure, the processor may determine the total erosion amount of the plurality of electrode blocks 1-1 in operation based on the erosion amount calculation model of the plurality of electrode blocks 1-1. For example, the processor may use an operation condition and an electrode material property as an input parameter of the erosion amount calculation model, and output the total erosion amount of the plurality of electrode blocks 1-1 in operation through the erosion amount calculation model. The operation condition may include at least a current density, an operation temperature, operation time, an electrolyte composition and concentration. The electrode material property may include at least a chemical property and a physical property (e.g., a density, a corrosion resistance, etc.) of the material of the electrode.

In 630, electrode blocks 1-1 with a same or similar erosion amount may be grouped to constitute an electrode module 1-2 based on the total erosion amount of the plurality of electrode blocks 1-1.

More descriptions regarding the plurality of electrode blocks 1-1 and the plurality of electrode modules 1-2 may be found in FIGS. 1-4 and the related descriptions thereof.

The processor may constitute an electrode module 1-2 from at least one of the plurality of electrode blocks 1-1 in various ways. In the embodiments of the present disclosure, the processor may group the plurality of electrode blocks 1-1 into a plurality groups of electrode blocks 1-1 based on a first preset rule, and determine the groups of the plurality of electrode blocks 1-1 as corresponding electrode modules 1-2. That is, one group of the plurality groups of electrode blocks 1-1 may correspond to one electrode module 1-2. In the embodiments of the present disclosure, the first preset rule may at least include an erosion amount of each of the at least one of the plurality of electrode blocks 1-1, a position of the at least one of the plurality of electrode blocks 1-1 in the electrode 1, and a grouping sequence.

In the embodiments of the present disclosure, the processor may determine grouping results of the plurality of electrode blocks 1-1 based on the erosion amount of each of the at least one of the plurality of electrode blocks 1-1, the position of the at least one of the plurality of electrode blocks 1-1 in the electrode 1, and a preset threshold. The processor may determine the plurality of electrode modules 1-2 based on the grouping results of the plurality of electrode blocks 1-1.

The position of the at least one of the plurality of electrode blocks 1-1 in the electrode 1 refers to a specific position of an electrode block 1-1 in an arrangement structure of the electrode 1. In the embodiments of the present disclosure, the position of the at least one of the plurality of electrode blocks 1-1 in the electrode 1 may include a length position (e.g., a depth position) and a width position of the electrode block 1-1 in the arrangement structure of the electrode 1. The length position refers to a position of the at least one of the plurality of electrode blocks 1-1 in the depth direction of the electrode 1, such as a distance from the electrode block 1-1 to the bottom of the kiln. The width position refers to a position of the at least one of the plurality of electrode blocks 1-1 in a direction perpendicular to the depth direction the electrode 1 (or parallel to the bottom of the kiln). In the embodiments of the present disclosure, the position of the at least one of the plurality of electrode blocks 1-1 may be represented by a serial number of the electrode block 1-1. The serial number of the electrode block 1-1 refers to an identifier of the electrode block 1-1. For example, the smallest serial number may represent an electrode block 1-1 at a starting position (e.g., a center position of the electrode 1), and the largest serial number may represent an electrode block 1-1 at an end position (e.g., the electrode block 1-1 located at the bottom of the kiln and closest to a side wall of the kiln).

The grouping sequence refers to an order of determining the grouping of an electrode block 1-1. In the embodiments of the present disclosure, the grouping sequence may include a fixed order and an arbitrary order. The fixed order means that the order of determining the grouping of the electrode block 1-1 is fixed. The processor may determine the grouping sequence of the electrode block 1-1 based on a position of the electrode block 1-1. For example, the processor may first determine a group to which an electrode block 1-1 located at the center of the electrode 1 belongs, and then determine a group to which an electrode block 1-1 adjacent to the electrode block 1-1 located at the center of the electrode belongs, and traverse the plurality of electrode blocks 1-1 outward in sequence. As another example, the processor may determine the grouping sequence of the electrode block 1-1 based on the serial number of the electrode block 1-1. For example, the processor may determine groups to which the corresponding electrode blocks 1-1 belong in a descending order based on the serial number. The arbitrary order means that the order of determining the grouping of the electrode block 1-1 is random and irregular.

The preset threshold refers to a preset reference value. In the embodiments of present disclosure, the preset threshold may be related to a statistical feature of the total erosion amount of the plurality of electrode blocks 1-1. For example, the preset threshold may be related to a mean value, a variance, or the like, of the total erosion amount corresponding to the plurality of electrode blocks 1-1.

In the embodiments of the present disclosure, the processor may determine the preset threshold value based on the mean value and the variance of the total erosion amount corresponding to the plurality of electrode blocks 1-1 and a preset coefficient k. For example, the preset threshold satisfies that the preset threshold value equals a product of the preset coefficient k, the mean value, and the variance. The preset coefficient k may be a preset coefficient automatically generated by the system or manually set. For example, the preset coefficient k may be 0.1.

The grouping results refer to a plurality of groups obtained by dividing the plurality of electrode blocks 1-1. In the embodiments of the present disclosure, the processor may divide the plurality of electrode blocks 1-1 into a plurality of groups based on a first preset rule to obtain the grouping results of the plurality of electrode blocks 1-1. The grouping results may include a count of groups, a count of electrode blocks 1-1 in a group, a group to which each electrode block 1-1 belongs, or the like.

The processor may determine the grouping results of the plurality of electrode blocks 1-1 in various ways. In the embodiments of the present disclosure, the processor may determine a pending group to which a target electrode block 1-1 belongs based on a preset grouping rule. The target electrode block 1-1 refers to an electrode block to be grouped or an undetermined group. The pending group refers to a pending group that includes the target electrode block 1-1 based on the preset grouping rule. For example, the processor may determine the pending group to which the target electrode block 1-1 belongs based on a comparison result between the target electrode block 1-1 and an adjacent electrode block 1-1.

In the embodiments of the present disclosure, in response to determining that the adjacent electrode block 1-1 belongs to an independent group (that is, the adjacent electrode block 1-1 is grouped separately), the processor may determine the group to which the target electrode block 1-1 belongs based on a difference between a total erosion amount of the target electrode block 1-1 and a total erosion amount of the adjacent electrode block 1-1. For example, in response to determining that the difference between the total erosion amount of the target electrode block 1-1 and the total erosion amount of the adjacent electrode block 1-1 is less than a preset threshold, the processor may determine the target electrode block 1-1 and the adjacent electrode block 1-1 as a group.

In the embodiments of the present disclosure, in response to determining that the adjacent electrode block 1-1 does not belong to an independent group (e.g., the group to which the adjacent electrode block 1-1 belongs includes at least two electrode blocks 1-1, and one of the at least two electrode blocks 1-1 is the adjacent electrode block 1-1 of the target electrode block 1-1), the processor may obtain a mean value of total erosion amounts corresponding to the at least two electrode blocks 1-1 in the group, and determine the group to which the target electrode block 1-1 belongs based on a difference between the mean value and the total erosion amount of the target electrode block 1-1. For example, in response to determining that the difference between the mean value and the total erosion amount of the target electrode block 1-1 is less than a preset threshold, the processor may determine the group as a pending group of the target electrode block 1-1.

In the embodiments of the present disclosure, the processor may determine a target group of the target electrode block 1-1 based on the pending group corresponding to the target electrode block 1-1. For example, the processor may determine the target group of the target electrode block 1-1 based on a count of pending groups. In response to determining that the count of the pending groups is 0, (e.g., the processor does not obtain the pending group of the target electrode block 1-1 based on the preset grouping rule), the processor may determine the target electrode block 1-1 as an independent group. In response to determining that the count of pending groups is 1, the processor may directly determine the pending grouping as the target group of the target electrode block 1-1. In response to determining that the count of the pending groups is greater than or equal to 2, the processor may obtain the total erosion amounts corresponding to the at least two pending groups or the mean value of the total erosion amounts, determine a difference between the total erosion amount of the target electrode block 1-1 and the total erosion amount of one of the at least two pending groups or a difference between the total erosion amount of the target electrode block 1-1 and the mean value of the total erosion amounts of the at least two pending groups, and determine a pending group corresponding to a minimum difference as the target group of the target electrode block 1-1.

In the embodiments of the present disclosure, the processor may traverse all target electrode blocks 1-1 based on the preset grouping rule to obtain the grouping results of the plurality of electrode blocks 1-1 of the electrode 1.

The processor may determine the plurality of electrode modules 1-2 in various ways. In the embodiments of the present disclosure, the processor may determine the plurality of electrode modules 1-2 based on the grouping results of the plurality of electrode blocks 1-1. For example, the processor may determine one group of the plurality groups of the electrode blocks 1-1 as an electrode module 1-2.

In the embodiments of the present disclosure, the processor may determine a plurality of grouping results corresponding to the plurality of electrode blocks 1-1 based on a plurality of grouping sequences corresponding to the plurality of electrode blocks 1-1, and determine the plurality of electrode modules 1-2 based on the plurality of grouping results.

In the embodiments of the present disclosure, the processor may obtain the plurality of grouping sequences corresponding to the plurality of electrode blocks 1-1, and determine a plurality of candidate grouping results corresponding to the plurality of grouping sequences based on the plurality of grouping sequences. Different grouping sequences may correspond to different grouping results. The processor may determine target grouping results of the plurality of electrode blocks 1-1 based on the plurality of candidate grouping results, and determine the plurality of electrode modules 1-2 based on the target grouping results.

In the embodiments of the present disclosure, the processor may determine grouping scores corresponding to the plurality of candidate grouping results based on a count of the plurality of electrode modules 1-2, an irregular proportion of the plurality of electrode modules 1-2, and a variance mean of the plurality of electrode modules 1-2. The processor may determine the target grouping results based on the grouping scores corresponding to the plurality of candidate grouping results. For example, the processor may determine a ranking of the plurality of grouping scores, and determine the target grouping result based on the ranking of the plurality of grouping scores.

The count of the plurality of electrode modules 1-2 refers to a count of electrode modules 1-2 corresponding to a candidate grouping result (e.g., a count of electrode modules 1-2 consisting of a plurality of electrode blocks 1-1 based on the candidate grouping results). The irregular proportion of the plurality of electrode modules 1-2 refers to a ratio of a count of irregularly shaped electrode modules 1-2 (e.g., specially shaped electrode modules 1-2) to a total count of the plurality of electrode modules 1-2. The irregularly shaped electrode modules 1-2 refer to electrode modules 1-2 that are not regular shapes such as a cuboid, a cube, or the like.

The variance mean of the plurality of electrode modules 1-2 refers to a mean value of variances corresponding to electrode modules 1-2 corresponding to a candidate grouping result. The variance of each electrode module 1-2 may be determined by a variance of a total erosion amount of electrode blocks 1-1 constituting the electrode module 1-2.

The count of the plurality of electrode modules 1-2, the irregular proportion of the plurality of electrode modules 1-2, and the variance mean of the plurality of electrode modules 1-2 may be negatively correlated with a first score, a second score, and a third score, respectively. The processor may determine a grouping score of the candidate grouping result based on the first score, the second score, and the third score. For example, the processor may determine a weighted sum of the first score, the second score, and the third score as the grouping score of the candidate grouping result. The processor may sort the plurality of grouping scores, and determine a candidate grouping result corresponding to the highest grouping score as the target grouping result, and determine the plurality of electrode modules 1-2 based on the target grouping result.

In 640, a plurality of silver plate modules 2-2 and a plurality of propulsion modules 4 corresponding to a plurality of electrode modules 1-2 may be designed according to the plurality of electrode modules 1-2.

More descriptions regarding the plurality of silver plate modules 2-2 may be found in FIGS. 1-3 and the related descriptions thereof. More descriptions regarding the plurality of propulsion modules 4 may be found in FIG. 5 and the related descriptions thereof. More descriptions regarding designing the plurality of silver plate modules 2-2 and the plurality of propulsion modules 4 corresponding to the plurality of electrode modules 1-2 may be found in FIGS. 1-5 and the related descriptions thereof.

In 650, a length of each of the plurality of electrode blocks 1-1 may be optimized based on the total erosion amount of the plurality of electrode blocks 1-1.

The length of each of the plurality of electrode blocks 1-1 refers to an initial length of each of the plurality of electrode blocks 1-1. In the embodiments of present disclosure, the length of each of the plurality of electrode blocks 1-1 may be positively correlated with the total erosion amount of the plurality of electrode blocks 1-1. More descriptions regarding the total erosion amount may be found in the operation 620 and the related descriptions thereof.

In the embodiments of the present disclosure, the processor may optimize the length of each of plurality of the electrode blocks 1-1 based on the relationship that the length of each of plurality of electrode blocks 1-1 is positively correlated with the total erosion amount of the plurality of electrode blocks 1-1. For example, when the total erosion amount is great, the processor may select an electrode block 1-1 with a great initial length. When the total erosion amount is small, the processor may select an electrode block 1-1 with a small initial length.

In 660, a daily consumption of the plurality of electrode blocks 1-1 may be determined based on a service life of the kiln and the total erosion amount of the plurality of electrode blocks 1-1.

The service life of the kiln refers to a duration during which the kiln can operate effectively. In the embodiments of the present disclosure, the service life of the kiln may be determined based on a plurality of factors, such as a design of the kiln, an operation condition, a maintenance strategy, etc.

The daily consumption refers to a mass or a volume of the plurality of electrode blocks 1-1 consumed in a single day due to chemical and electrochemical reactions, physical wear, etc., which reflects a daily loss degree of the plurality of electrode blocks 1-1. In the embodiments of the present disclosure, the daily consumption of the plurality of electrode blocks 1-1 may be at least positively correlated with the service life of the kiln, an operation temperature, a current density, a chemical composition of substrate glass raw materials, and operation time.

The processor may determine the daily consumption of the plurality of electrode blocks 1-1 in various ways. In the embodiments of the present disclosure, the processor may determine the daily consumption of the plurality of electrode blocks 1-1 based on the service life of the kiln and the total erosion amount of the plurality of electrode blocks 1-1. For example, the processor may obtain the service life (e.g., 5-10 years) of the kiln and the total erosion amount of the plurality of electrode blocks 1-1, convert the service life of the kiln into days, and divide the total erosion amount of the plurality of electrode block 1-1 by the converted service life of the kiln to determine the daily consumption of the plurality of electrode blocks 1-1.

In 670, the daily consumption of the plurality of electrode blocks 1-1 may be corrected based on the erosion rule analysis of the electrode simulated by the kiln flow field.

The processor may correct the daily consumption of the plurality of electrode blocks 1-1 in various ways. In the embodiments of the present disclosure, the processor may correct the daily consumption of the plurality of electrode block 1-1 by correcting the total erosion amount of the plurality of electrode block 1-1. In the embodiments of the present disclosure, the processor may adjust a parameter of the erosion amount calculation model based on the erosion rule analysis of the electrode simulated by the kiln flow field to obtain an updated erosion amount calculation model. For example, the processor may determine the updated erosion amount calculation model by obtaining the latest experimental result data (e.g., total erosion amounts under different process conditions, the process conditions, etc.) and removing abnormal data. The abnormal data refers to data that obviously does not conform to the electrode erosion rule. The processor may obtain the latest experimental result data through an experimental result database, and remove the abnormal data through data cleaning. More descriptions regarding the erosion amount calculation model may be found in the operation 610 and the related descriptions thereof.

The processor may determine a corrected daily consumption of the plurality of electrode blocks 1-1 based on the corrected total erosion amount output by the updated erosion amount calculation model and the service life of the kiln. More descriptions regarding the total erosion amount of the plurality of electrode blocks 1-1 and the erosion amount calculation model may be found in the operation 610 and the operation 620 and the related descriptions thereof.

In 680, an electrode consumption of the plurality of electrode modules 1-2 during an electrode propulsion cycle may be determined based on the electrode propulsion cycle.

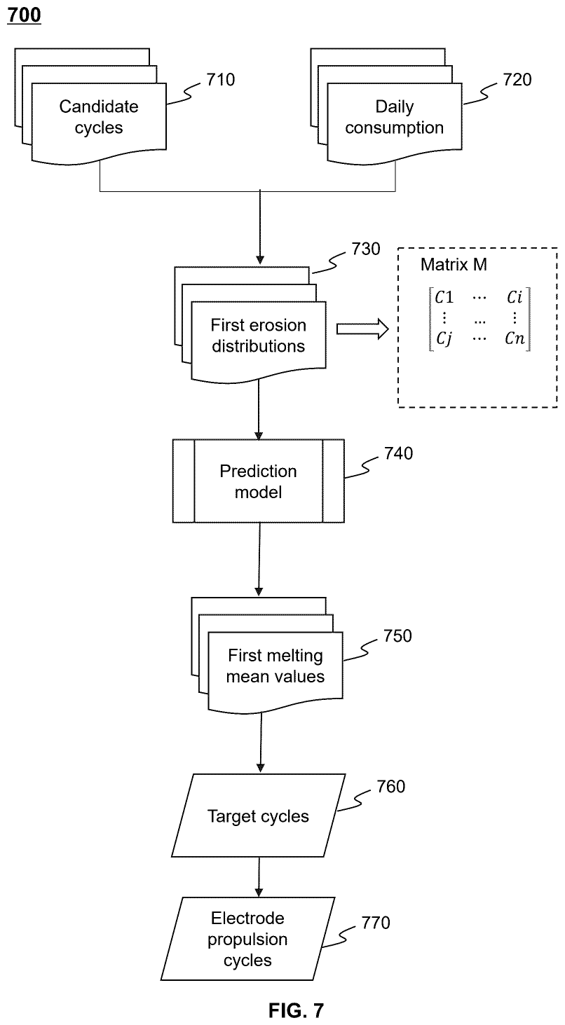

The electrode propulsion cycle refers to a time interval required for the plurality of electrode modules 1-2 to propel once. In the embodiments of present disclosure, the electrode propulsion cycle may be at least negatively correlated with an electrode consumption rate, an operation temperature, a production rate, an electrode material, and an electrode design. For example, the electrode propulsion cycle may be N days or N hours. More descriptions regarding the electrode propulsion cycle and the determination thereof may be found in FIG. 7 and related descriptions thereof.

The electrode consumption refers to a mass or a volume consumed by the plurality of electrode modules 1-2 due to chemical and electrochemical reactions, physical wear, etc., which reflects a wear degree of the plurality of electrode blocks 1-2. In the embodiments of the present disclosure, the electrode consumption of the plurality of electrode module 1-2 may be at least positively correlated with the service life of the kiln, the operation temperature, the current density, the chemical composition of the substrate glass raw materials, the operation time, and the daily consumption of the plurality of electrode blocks 1-1 constituting the plurality of electrode modules 1-2.

The processor may determine the electrode consumption of the plurality of electrode modules 1-2 in various ways. In the embodiments of the present disclosure, the processor may determine the electrode consumption of the plurality of electrode modules 1-2 during the electrode propulsion cycle based on the corrected daily consumption of the plurality of electrode blocks 1-1 and the electrode propulsion cycle. For example, the processor may obtain the electrode propulsion cycle and a corrected daily consumption of each electrode block 1-1 constituting the electrode module 1-2, determine a sum of the corrected daily consumptions of the electrode blocks 1-1 as the daily consumption of the electrode module 1-2, and determine a product of the daily consumption of the electrode module 1-2 and the electrode propulsion cycle as the electrode consumption of the electrode module 1-2 during the electrode propulsion cycle.

In 690, the electrode 1 may be propelled with unequal propulsion amounts by the plurality of propulsion modules 4 based on the electrode consumption of the plurality of electrode modules 1-2 during the electrode propulsion cycle.

Propelling the electrode with unequal propulsion amounts refers to unequal propulsion of the plurality of electrode blocks 1-1 or the plurality of electrode modules 1-2 that constitute the electrode 1. In the embodiments of the present disclosure, the plurality of electrode blocks 1-1 or the plurality of electrode modules 1-2 may have different propulsion amounts during the electrode propulsion cycle. The propulsion amount refers to a propulsion distance of the plurality of electrode blocks 1-1 or the plurality of electrode modules 1-2 during the electrode propulsion cycle. In the embodiments of the present disclosure, the plurality of electrode blocks 1-1 or the plurality of electrode modules 1-2 may have corresponding electrode propulsion cycles and corresponding propulsion amounts, respectively. For example, the plurality of electrode blocks 1-1 or the plurality of electrode modules 1-2 may have different propulsion cycles and propulsion amounts corresponding to the propulsion cycles.

The processor may realize the unequal propulsion amounts of the electrode 1 through the plurality of propulsion modules 4 in various ways. In the embodiments of the present disclosure, the electrode consumption of the plurality of electrode modules 1-2 during the electrode propulsion cycle may be related to propulsion amounts of the plurality of electrode modules 1-2. For example, the processor may determine the propulsion amounts of the plurality of electrode modules 1-2 during the electrode propulsion cycle based on the electrode consumption of the plurality of electrode module 1-2 during the electrode propulsion cycle. The electrode consumption of the plurality of electrode modules 1-2 during the electrode propulsion cycle may be positively correlated to the propulsion amounts of the plurality of electrode modules 1-2 during the electrode propulsion cycle. That is, the greater the electrode consumption of the plurality of electrode module 1-2, the greater the corresponding propulsion amount. The processor may propel, based on the propulsion amounts of the plurality of electrode modules 1-2 during the electrode propulsion cycle, the plurality of electrode modules 1-2 through the plurality of propulsion modules 4 corresponding to the plurality of electrode modules 1-2.

The embodiments of the present disclosure provide a propulsion method of an electrode propulsion structure with an unequal propulsion amount based on an electrode erosion rule. The propulsion method may comprise the following operations.

1) An erosion amount calculation model for at least one of the plurality of electrode blocks 1-1 of the electrode 1 at multiple temperatures may be established based on an erosion rule of the electrode after a kiln is disassembled and an erosion rule analysis of the electrode simulated by a kiln flow field. A total erosion amount of the plurality of electrode blocks 1-1 in operation (e.g., a total propulsion amount) may be calculated.

2) Electrode blocks 1-1 with a same or similar erosion amount may be grouped to constitute an electrode module 1-2 based on the total erosion amount of the plurality of electrode blocks 1-1, and a plurality of silver plate modules 2-2 and a plurality of propulsion modules 4 corresponding to a plurality of electrode modules 1-2 may be designed according to the plurality of electrode modules 1-2. Meanwhile, a length of each of the plurality of electrode blocks 1-1 may be optimized based on the total erosion amount of the plurality of electrode blocks 1-1. That is, an initial length of an electrode block 1-1 with a relatively great total erosion amount is longer, and an initial length of an electrode block 1-1 with a relatively small total erosion amount is shorter.

3) A daily consumption of the plurality of electrode blocks 1-1 may be determined based on a service life of the kiln and the total erosion amount of the plurality of electrode blocks 1-1, and the daily consumption of the plurality of electrode blocks 1-1 may be corrected based on the erosion rule analysis of the electrode simulated by the kiln flow field. An electrode propulsion cycle may be set to N days, and an electrode consumption of the plurality of electrode modules 1-2 during the electrode propulsion cycle may be determined.

4) The electrode 1 may be propelled with unequal propulsion amounts by the plurality of propulsion modules 4 of the electrode 1 based on the electrode consumption of the plurality of electrode modules 1-2 during 1-2 electrode propulsion cycles (e.g., N days). For example, the cooling air may be reduced, the temperature of the liquid glass near the electrode 1 may be increased, and the electrode 1 may be propelled with unequal propulsion amounts by the plurality of propulsion modules 4 of the electrode 1 based on the electrode consumption of the plurality of electrode modules 1-2 during 1-2 electrode propulsion cycles.

According to some embodiments of the present disclosure, the erosion amount calculation model for each of the plurality of electrode blocks 1-1 of the electrode 1 at different temperatures may be established based on the erosion rule of the electrode 1 after the kiln is disassembled and the erosion rule analysis of the electrode 1 simulated by the kiln flow field. The total propulsion amount of the plurality of electrode blocks 1-1 in operation may be determined according to the established erosion amount calculation model for each of the plurality of electrode blocks 1-1 of the electrode 1 at different temperatures to achieve unequal propulsion amounts of the plurality of electrode blocks 1-1 in the electrode 1, and ensure that the contact surface between the electrode 1 and the liquid glass is always a plane and flush with the wall, so as to achieve uniform distribution of the current of the electrode 1 and the liquid glass, achieve uniform melting of the liquid glass in the kiln, and further reduce the erosion of the liquid glass on the wall brick near the electrode 1. The length of each of the plurality of electrode blocks 1-1 is optimized according to the established erosion amount calculation model for each of the plurality of electrode blocks 1-1 of the electrode 1 at different temperatures. The initial length of the electrode block 1-1 with a relatively great erosion amount is longer, and the initial length of the electrode block 1-1 with a relatively small erosion amount is shorter. With the design of unequal lengths of the plurality of electrode blocks 1-1, the efficient utilization of each electrode block 1-1 is facilitated, thereby extending the service life of the electrode 1 and reducing the cost. The electrode blocks 1-1 with the same or similar erosion amount are grouped to constitute the electrode module 1-2 according to the erosion amount calculation model for each of the plurality of electrode blocks 1-1 of the electrode 1 at different temperatures. The plurality of silver plate modules 2-2 and the plurality of propulsion modules 4 corresponding to the plurality of electrode modules 1-2 are designed according to the plurality of electrode modules 1-2, and the plurality of electrode modules 1-2 are propelled with unequal propulsion amounts, so as to ensure that the contact surface between the electrode 1 and the liquid glass is a plane while improving the propulsion efficiency of the electrode 1.

FIG. 7 is a schematic diagram illustrating an exemplary process of determining an electrode propulsion cycle according to some embodiments of the present disclosure.

In the embodiments of the present disclosure, the processor may determine a plurality of candidate cycles 710. The processor may determine a plurality of first erosion distributions 730 based on daily consumptions 720 corresponding to the plurality of electrode blocks 1-1 and the plurality of candidate cycles 710. The processor may determine a plurality of first melting mean values 750 corresponding to the plurality of first erosion distributions based on the plurality of first erosion distributions 730 using a first prediction model 740. The processor may determine target cycles 760 based on the plurality of first melting mean values 750, and determine the target cycles as electrode propulsion cycles 770.

The plurality of candidate cycles 710 refer to alternative cycles for the electrode propulsion cycles. The plurality of candidate cycles 710 may be generated by the system or set manually. In the embodiments of the present disclosure, the plurality of candidate cycles 710 may be set to 4 days, 5 days, 6 days, etc. In the embodiments of the present disclosure, the plurality of candidate cycles 710 may be greater than a preset cycle value. The preset cycle value may be determined based on prior experience and/or historical data. For example, the preset cycle value may be 3 days. More descriptions regarding the electrode propulsion cycle may be found in the operation 680 and the related descriptions thereof.

The first erosion distribution 730 refers to an erosion condition of the electrode blocks 1-1 at one end of the liquid glass in a candidate cycle 710. In the embodiments of the present disclosure, the first erosion distribution 730 may at least include an erosion rate (a length, mass or volume loss of the electrode block 1-1 at one end of the liquid glass per unit time), an erosion depth, and an area distribution.

The processor may determine the plurality of first erosion distributions 730 in various ways. In the embodiments of the present disclosure, the processor may determine corresponding first erosion distributions 730 based on the plurality of candidate cycles 710 and the daily consumption 720 of the plurality of electrode blocks 1-1. For example, the processor may determine a product of one candidate cycle 710 and the daily consumption 720 of one electrode block 1-1 as a total consumption C1 of the electrode block 1-1. The processor may determine a consumption matrix M based on the total consumptions C1, C2, C3, . . . , Cn (n denotes a count of the electrode blocks 1-1) corresponding to the plurality of electrode blocks 1-1, and determine the consumption matrix M as the first erosion distribution 730 corresponding to the candidate cycle. More descriptions regarding the daily consumption 720 of the plurality of electrode blocks 1-1 may be found in FIG. 6 and the related descriptions thereof.

In the embodiments of the present disclosure, the first prediction model 740 may be a machine learning model, such as any one of a neural network (NN) model, a deep neural network (DNN) model, or other custom model structures, or any combination thereof.

The first melting mean value 750 refers to a melting mean value of the liquid glass. In the embodiments of the present disclosure, the first melting mean value 750 reflects the uniformity of the melting of the liquid glass. For example, the first melting mean value 750 may be 95%, 97%, etc.

In the embodiments of the present disclosure, the plurality of first melting mean values 750 may be determined through the first prediction model 740.

In the embodiments of the present disclosure, an input of the first prediction model 740 may include the plurality of first erosion distributions 740 corresponding to the plurality of candidate periods 710, and an output of the first prediction model 740 may include the plurality of first melting mean values 750.

The first prediction model 740 may be obtained by training based on at least one set of training samples and labels corresponding to the training samples. In the embodiments of the present disclosure, the training samples may include at least one set of sample first erosion distributions. The labels corresponding to the training samples may be obtained by heating glass through a sample electrode block and sampling a melting uniformity of the liquid glass. The melting uniformity of the liquid glass may be expressed as a percentage. For example, the melting uniformity of the liquid glass may be 95%. In the embodiments of the present disclosure, a set of sample first erosion distributions may correspond to a set of labels. The first sample erosion distributions of the sample electrode block may be determined by measuring a length of the sample electrode block through a length measurement device. The length measurement device may include a laser rangefinder, an infrared rangefinder, or the like.

During training, the training samples may be input into an initial prediction model, a loss function may be constructed based on outputs of the initial prediction model and the labels, and parameters of the initial prediction model may be iteratively updated based on the loss function until a preset training condition is met. A trained prediction model may be obtained after the training is ended. The trained prediction model may be used as the first prediction model 740. The preset training condition may include but is not limited to that the loss function converges, a count of iterations is greater than a threshold, or the like.

In the embodiments of the present disclosure, the processor may determine the target cycles 760 based on the plurality of first melting mean values 750. For example, the processor may obtain the plurality of first melting mean values 750 through the first prediction model 740, and compare the plurality of first melting mean values 750 with a preset melting threshold, respectively. The preset melting threshold may be determined based on prior experience and/or historical data. The preset melting threshold may also be set manually. The processor may determine at least one corresponding candidate cycle 710 based on at least one first melting mean value 750 that is less than the preset melting threshold, and determine the minimum candidate cycle 710 of the at least one candidate cycle 710 as the target cycle 760. The processor may determine the target cycle 760 as the electrode propulsion cycle 770.

In the embodiments of the present disclosure, the processor may determine a propulsion cycle corresponding to each of the plurality of electrode modules 1-2 based on target grouping results of the plurality of electrode blocks 1-1. The processor may generate a target cycle sequence based on the propulsion cycle corresponding to each of the plurality of electrode modules 1-2, and determine the target cycle sequence as the electrode propulsion cycle.

In the embodiments of the present disclosure, the processor may determine a plurality of candidate cycle sequences. One of the plurality of candidate cycle sequences may include a plurality of propulsion cycles, and one of the plurality of propulsion cycles may correspond to one of the plurality of electrode modules 1-2. The processor may determine a plurality of second erosion distributions based on a plurality of daily consumptions corresponding to the plurality of electrode blocks 1-1 and a plurality of candidate propulsion cycle sequences. The processor may determine a plurality of second melting mean values corresponding to the plurality of second erosion distributions through the first prediction model based on a plurality of candidate second erosion distributions, and determine the target cycle sequences based on the plurality of second melting mean values.

In the embodiments of the present disclosure, the plurality of candidate cycle sequences may be generated by the system or set manually. In the embodiments of the present disclosure, the processor may adjust a plurality of propulsion cycles in the plurality of candidate cycle sequences based on the target cycles. For example, the processor may increase a propulsion cycle of an electrode block 1-1 with a relatively small daily consumption and decrease a propulsion cycle of an electrode block 1-1 with a relatively large daily consumption based on the target cycle. The electrode block 1-1 with the relatively small daily consumption refers to an electrode block 1-1 whose daily consumption is less than a preset consumption threshold. The electrode block 1-1 with a relatively large daily consumption refers to an electrode block 1-1 whose daily consumption is greater than or equal to the preset consumption threshold. The preset consumption threshold may be determined based on prior experience and/or historical data. The preset consumption threshold may also be set manually. For example, the preset consumption threshold may be a mean value of the daily consumptions corresponding to the plurality of electrode blocks 1-1. A plurality of propulsion cycles in the plurality of candidate cycle sequences need to be greater than the preset cycle value.

In the embodiments of the present disclosure, the processor may sort the plurality of second melting mean values. The processor may determine a candidate cycle sequence corresponding to the maximum second melting mean value as the target cycle sequence. The processor may determine the target cycle sequence as the electrode propulsion cycle. The plurality of second erosion distributions may be similar to the plurality of first erosion distributions, and the plurality of second melting mean values may be similar to the plurality of first melting mean values, which may be found in the related descriptions of the plurality of first erosion distributions and the plurality of first melting mean values, respectively.

In the embodiments of the present disclosure, the plurality of first erosion distributions are determined through the daily consumptions corresponding to the plurality of electrode blocks 1-1 and the plurality of candidate cycles. The plurality of first erosion distributions are used as the input of the prediction model. The prediction model outputs the plurality of corresponding first melting mean values. The target cycles are determined based on the plurality of first melting mean values and used as the electrode propulsion cycles, such that an accurate electrode propulsion cycle can be obtained, thereby improving the accuracy of the propulsion amount of the electrode propulsion structure with the unequal propulsion amount, achieving efficient utilization of each of the plurality of electrode blocks 1-1, and extending the service life of the electrode 1.

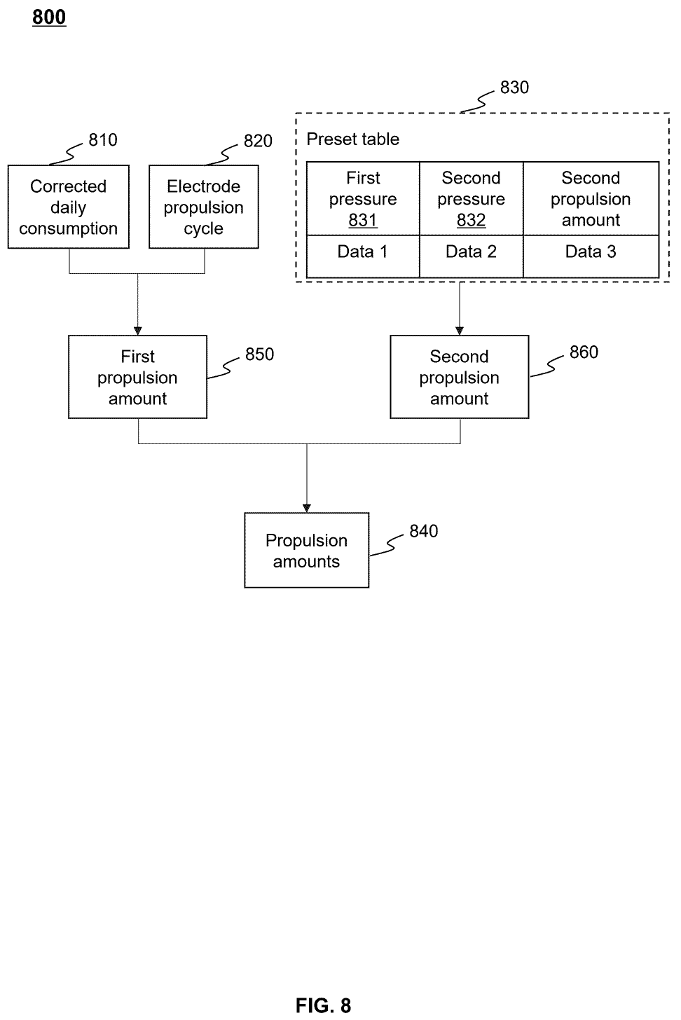

FIG. 8 is a schematic diagram illustrating an exemplary process of determining a propulsion amount according to some embodiments of the present disclosure.

The processor may determine the propulsion amount of an electrode propulsion structure with an unequal propulsion amount in various ways. In the embodiments of the present disclosure, the processor may determine the propulsion amount of the electrode propulsion structure with the unequal propulsion amount based on historical data. The historical data may include at least a statistical value (e.g., a maximum value, a minimum value, a mean value, or the like, of the propulsion amount) of a propulsion amount of the plurality of electrode blocks 1-1 or the plurality of electrode modules 1-2 of the electrode 1.

In the embodiments of the present disclosure, the processor may determine plurality of propulsion amounts 840 of the plurality of electrode blocks 1-1 based on a corrected daily consumption 810 corresponding to the plurality of electrode blocks 1-1, an electrode propulsion cycle 820, and pressure data 830. More descriptions regarding the corrected daily consumption 810 corresponding to the plurality of electrode blocks 1-1 and the plurality of propulsion amounts 840 of the plurality of electrode blocks 1-1 may be found FIG. 6 and the related descriptions thereof. More descriptions regarding the electrode propulsion cycle 820 may be found in FIG. 6 and FIG. 7 and the related descriptions thereof. More descriptions regarding the pressure data 830 may be found in FIG. 5 and the related descriptions thereof.

In the embodiments of the present disclosure, the processor may determine a first propulsion amount 850 based on the corrected daily consumption 810 corresponding to the plurality of electrode blocks 1-1 and the electrode propulsion cycle 820. The first propulsion amount 850 refers to a total consumption of the plurality of electrode blocks 1-1 during the electrode propulsion cycle 820. For example, the processor may determine a product of the corrected daily consumption 810 corresponding to the plurality of electrode blocks 1-1 and the electrode propulsion cycle 820 as the first propulsion amount 850.

In the embodiments of the present disclosure, the processor may determine a second propulsion amount 860 based on the pressure data 830. The pressure data 830 may include a first pressure 831 and a second pressure 832. The first pressure 831 refers to a pressure required for the electrode module top plates 4-1 to propel the plurality of electrode modules 1-2 consisting of the plurality of electrode blocks 1-1 before the electrode propulsion cycle 820. The second pressure 832 refers to a pressure required for the electrode module top plates 4-1 to propel the plurality of electrode modules 1-2 after the electrode propulsion cycle 820.

The pressure data 830 (e.g., the first pressure 831 and the second pressure 832) may be positively correlated to a mass of each of the plurality of electrode modules 1-2. That is, the greater the mass of each of the plurality of electrode modules 1-2, the greater the pressure data 830. The processor may determine the mass of each of the plurality of electrode module 1-2 based on a mass of each of the plurality of electrode blocks 1-1 constituting the plurality of electrode modules 1-2.

In the embodiments of the present disclosure, the processor may evaluate a total consumption of the plurality of electrode blocks 1-1 during the electrode propulsion cycle 820 based on the first pressure 831 and the second pressure 832. The processor may further evaluate a total consumption (e.g., an electrode consumption) of the plurality of electrode modules 1-2. For example, the processor may evaluate the total consumption (e.g., the electrode consumption) of the plurality of electrode module 1-2 during the electrode propulsion cycle 820 based on a difference between the first pressure 831 and the second pressure 832.

In the embodiments of the present disclosure, the processor may determine the second propulsion amount 860 by querying a preset table based on the first pressure 831 and the second pressure 832. In the embodiments of the present disclosure, the preset table may include a correspondence between the first pressure 831, the second pressure 832, and the second propulsion amount 860. In the embodiment of the present disclosure, the preset table may be constructed based on historical data.

In the embodiment of the present disclosure, the processor may determine the propulsion amount of the plurality of electrode blocks 1-1 based on the first propulsion amount 850 and the second propulsion amount 860. In the embodiments of the present disclosure, the propulsion amount 840 satisfies that the propulsion amount=A1*the first propulsion amount+A2*the second propulsion amount, where A1 and A2 denote preset coefficients that can be generated by the system or set manually. For example, both A1 and A2 may be set to 0.5.

According to the embodiments of the present disclosure, the pressure change during the process of propelling the plurality of electrode modules 1-2 consisting of the plurality of electrode blocks 1-1 can be obtained in real time based on the corrected daily consumption of the plurality of electrode blocks 1-1 of the electrode 1 and the propulsion cycle of the electrode 1 in conjunction with the pressure data obtained by the pressure sensor 4-4 disposed on the electrode module top plate 4-1, such that the total consumption of each electrode block 1-1 and/or electrode module 1-2 can be accurately obtained, so as to accurately determine the corresponding propulsion amount, and ensure the effect of unequal propulsion amounts of the electrode.

The above contents are only for explaining the technical idea of the present disclosure and cannot be used to limit the protection scope of the present disclosure. Any changes made on the basis of the technical solution in accordance with the technical idea proposed by the present disclosure shall fall within the protection scope of the claims of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An electrode propulsion structure with an unequal propulsion amount based on an electrode erosion rule, the electrode propulsion structure comprising an electrode, a silver plate disposed within the electrode, and a plurality of propulsion modules disposed at a tail end of the electrode; wherein
the electrode include a plurality of electrode blocks, and at least one of the plurality of electrode blocks constitutes an electrode module;
the silver plate includes a plurality of silver plate modules, and at least one of a plurality of electrode modules is provided with a silver plate module and at least one of the plurality of propulsion modules corresponding to the at least one of plurality of propulsion modules.

2. The electrode propulsion structure of claim 1, wherein an erosion amount of each of the at least one of the plurality of electrode blocks constituting the electrode module is the same or similar.

3. The electrode propulsion structure of claim 1, wherein the silver plate includes a plurality of silver plate blocks.

4. The electrode propulsion structure of claim 3, wherein the plurality of silver plate modules corresponding to the plurality of electrode modules are designed according to the plurality of electrode modules;
in response to determining that a single electrode block of the plurality of electrode blocks constitutes the electrode module, the silver plate module consists of a single silver plate block;
in response to determining that more than one electrode block constitutes the electrode module, the silver plate module consists of more than one silver plate block.

5. The electrode propulsion structure of claim 4, wherein no silver plate block is disposed in a middle region of the silver plate module consisting of more than one silver plate block.

6. The electrode propulsion structure of claim 3, wherein at least one of the plurality of electrode blocks is a cuboid electrode block, and step grooves are disposed at a periphery of the cuboid electrode block.

7. The electrode propulsion structure of claim 6, wherein at least one of the plurality of silver plate blocks is embedded in step grooves of adjacent electrode blocks, and the plurality of silver plate blocks are connected in series.

8. The electrode propulsion structure of claim 7, wherein a width of each of the plurality of silver plate blocks is less than a depth of each of the step grooves.

9. The electrode propulsion structure of claim 1, wherein each of the plurality of propulsion modules includes an electrode module top plate, a top screw, and a propulsion support which are disposed at a tail end of each of the plurality of electrode modules in sequence; one end of the top screw is fixed on the electrode module top plate, the top screw is insulated from the electrode module top plate, the other end of the top screw is connected with the propulsion support, and the propulsion support is fixed on the ground.

10. The electrode propulsion structure of claim 9, wherein the electrode module top plate is used in conjunction with each of the plurality of electrode modules, and the plurality of propulsion modules include a plurality of electrode module top plates which are independent of each other.

11. The electrode propulsion structure of claim 1, wherein an electric flange is disposed at a top end of the silver plate.

12. The electrode propulsion structure of claim 1, wherein cooling air is provided near the electrode.

13. The electrode propulsion structure of claim 9, wherein a pressure sensor is disposed on the electrode module top plate, and the pressure sensor is configured to obtain pressure data when the plurality of electrode modules are propelled.

14. An electrode propulsion method, implemented by a processor, the electrode propulsion method comprising:
establishing an erosion amount calculation model for at least one of a plurality of electrode blocks at multiple temperatures based on an erosion rule of an electrode after a kiln is disassembled and an erosion rule analysis of the electrode simulated by a kiln flow field;
determining a total erosion amount of the plurality of electrode blocks in operation based on the erosion amount calculation model;
grouping electrode blocks with a same or similar erosion amount to constitute an electrode module based on the total erosion amount of the plurality of electrode blocks;
designing a plurality of silver plate modules and a plurality of propulsion modules corresponding to a plurality of electrode modules according to the plurality of electrode modules;
optimizing a length of each of the plurality of electrode blocks based on the total erosion amount of the plurality of electrode blocks;
determining a daily consumption of the plurality of electrode blocks based on a service life of the kiln and the total erosion amount of the plurality of electrode blocks;
correcting the daily consumption of the plurality of electrode blocks based on the erosion rule analysis of the electrode simulated by the kiln flow field;
determining an electrode consumption of the plurality of electrode modules during an electrode propulsion cycle based on the electrode propulsion cycle; and
propelling the electrode with unequal propulsion amounts by the plurality of propulsion modules based on the electrode consumption of the plurality of electrode modules during the electrode propulsion cycle.

15. The propulsion method of claim 14, wherein the grouping electrode blocks with the same or similar erosion amount to constitute an electrode module based on the total erosion amount of the plurality of electrode blocks includes:
determining grouping results of the plurality of electrode blocks based on the total erosion amount of the plurality of electrode blocks, positions of the plurality of electrode blocks, and a preset threshold; and
determining the plurality of electrode modules based on the grouping results of the plurality of electrode blocks.

16. The propulsion method of claim 15, wherein the preset threshold is related to a statistical characteristic of the total erosion amount of the plurality of electrode blocks.

17. The propulsion method of claim 15, further comprising:
obtaining a plurality of grouping sequences corresponding to the plurality of electrode blocks;
determining a plurality of candidate grouping results corresponding to the plurality of grouping sequences based on the plurality of grouping sequences;
determining target grouping results of the plurality of electrode blocks based on the plurality of candidate grouping results; and
determining the plurality of electrode modules based on the target grouping results.

18. The propulsion method of claim 14, wherein the electrode propulsion cycle is determined by:
determining a plurality of candidate cycles;
determining a plurality of first erosion distributions based on the daily consumption corresponding to the plurality of electrode blocks and the plurality of candidate cycles;
determining a plurality of first melting mean values corresponding to the plurality of first erosion distributions based on the plurality of first erosion distributions using a first prediction model, the first prediction model being a machine learning model; and
determining target cycles based on the plurality of first melting mean values.

19. The propulsion method of claim 18, further comprising:
determining a plurality of candidate cycle sequences, wherein one of the plurality of candidate cycle sequences includes a plurality of propulsion cycles, and one of the plurality of propulsion cycles corresponds to one of the plurality of electrode modules;
determining a plurality of second erosion distributions based on the daily consumption corresponding to the plurality of electrode blocks and the plurality of candidate cycle sequences;
determining a plurality of second melting mean values corresponding to the plurality of second erosion distributions based on the plurality of second erosion distributions using the first prediction model; and
determining target period sequences based on the plurality of second melting means.

20. The propulsion method of claim 14, further comprising:
determining a plurality of propulsion amounts of the plurality of electrode blocks based on a corrected daily consumption corresponding to the plurality of electrode blocks, the electrode propulsion cycle, and pressure data.
